(19) United States
(12) Patent Application Publication
(10) Pub. No.: US 2026/0161774 A1
(43) Pub. Date: Jun. 11, 2026

(54) GenAI-Powered Discovery of Evolving Cybersecurity Threat Campaigns

(71) Applicant: Zscaler, Inc., San Jose, CA (US)

(72) Inventors: Praveen Tiwari, Milpitas, CA (US); Charanraj Thimmisetty, Dublin, CA (US); Sofia Nedorosleva, Santa Clara, CA (US); Hardik Sakhuja, Mountain View, CA (US); Sudipto Guha, Los Altos, CA (US)

(73) Assignee: Zscaler, Inc., San Jose, CA (US)

(21) Appl. No.: 18/972,311

(22) Filed: Dec. 6, 2024

(51) Int. Cl. G06F 21/55

(52) U.S. Cl. CPC G06F 21/554; G06F 2221/034

(57) ABSTRACT

Systems and methods for executing an evolving threat campaign discovery pipeline are provided. A method, according to one implementation, includes a step of utilizing a harvester stage of an evolving threat campaign discovery pipeline, the harvester stage configured to perform a continuous open web crawling action to obtain initial threat information from external sources. The method also includes a step of utilizing an examiner stage of the evolving threat campaign discovery pipeline, the examiner stage configured to perform automated and human-assisted vetting of the initial threat information to obtain verified threat data. Also, the method includes utilizing a curator stage of the evolving threat campaign discovery pipeline, the curator stage configured to record the verified threat data in a threat campaign database to monitor and maintain knowledge of an evolving threat campaign.

### TECHNICAL FIELD

The present disclosure generally relates to cybersecurity systems and methods. More particularly, the present disclosure relates to a Generative Artificial Intelligence (GenAI) process for discovering an evolving cybersecurity threat campaign.

### BACKGROUND

Cybersecurity threats are evolving rapidly, with malicious actors continuously refining their techniques to evade detection. Traditional threat intelligence systems rely heavily on manual inputs, pre-structured feeds, and semi-automated workflows. These methods are often constrained by delayed updates, scalability issues, and a lack of adaptability in addressing new and emergent threats. Current systems are limited in their ability to provide real-time insights, requiring significant human oversight to filter and validate data from disparate sources. The increasing complexity of modern threat campaigns, coupled with the diversity of data sources (e.g., social media, dark web content, government databases, etc.), thereby necessitates a more dynamic and efficient approach to gathering, vetting, and analyzing threat intelligence.

### BRIEF SUMMARY

The present disclosure focuses on the ever-changing battle between nefarious attackers and cybersecurity specialists. One way to combat the enemy in this respect is to obtain as much knowledge as possible from multiple sources, coordinate efforts to obtain a comprehensive knowledge base of the enemy's tactics and procedures, and then take decisive remediation actions to thwart the enemy's attacks. The systems and methods of the present disclosure are configured to focus on the data gathering and coordination efforts in this respect. In one implementation for discovering an evolving threat campaign, a method includes a step of utilizing a harvester stage of an evolving threat campaign discovery pipeline, whereby the harvester stage is configured to perform a continuous open web crawling action to obtain initial threat information from external sources. Also, the method includes a step of utilizing an examiner stage of the evolving threat campaign discovery pipeline, whereby the examiner stage is configured to perform automated and human-assisted vetting of the initial threat information to obtain verified threat data. Furthermore, the method includes a step of utilizing a curator stage of the evolving threat campaign discovery pipeline, whereby the curator stage is configured to record the verified threat data in a threat campaign database to maintain knowledge of an evolving threat campaign. According to some embodiments, Generative Artificial Intelligence (GenAI) models are integrated in one or more of the harvester stage, examiner stage, and curator stage of the evolving threat campaign discovery pipeline.

In some embodiments, the method may further include additional features, as described herein. For example, the harvester stage may include one or more Large Language Models (LLMs) for context-aware parsing of the initial threat information. The harvester stage may also include an expansion of search queries based on emerging patterns. The examiner stage, for instance, may include transformer-based models for automated threat assessment to validate the credibility of the initial threat data. Also, the examiner stage may further include one or more Generative Adversarial Networks (GANs) for simulating potential attack scenarios and/or may further include one or more neural networks for identifying correlations between threat indicators. In addition, the curator stage may include one or more of a) graph neural networks for efficient threat graph updates and analysis, b) generative models for predicting potential threat evolution paths, and c) sequence models for projecting campaign progression.

The evolving threat campaign discovery pipeline, according to some implementations, may include multiple agents for manual and automated processing. The external sources, for instance, may include websites, threat feeds, VirusTotal, social media, dark web, Common Vulnerabilities and Exposures (CVE) sites, and/or government-maintained threat lists. The threat campaign database, in some embodiments, may include a hybrid database, a knowledge base, and/or a vector database. In some embodiments, a User Interface (UI) may be configured to receive queries (from a user or security specialist), interpret the queries using Natural Language Processing (NLP), initiate the evolving threat campaign discovery pipeline, and respond to the queries using NLP.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a threat intelligence system, according to various embodiments.

FIG. 2 is a block diagram illustrating another threat intelligence system, according to various embodiments.

FIG. 3 is a flow diagram illustrating a process for discovering threat campaigns, according to various embodiments.

FIGS. 4A and 4B are screenshots of a User Interface (UI) showing a harvester dashboard, according to various embodiments.

FIGS. 5A and 5B are screenshots of a UI showing an examiner dashboard, according to various embodiments.

FIGS. 6A and 6B are screenshots of a UI showing a curator dashboard, according to various embodiments.

FIGS. 7 and 8 are flow diagrams illustrating examples of threat discovery processes, according to various embodiments.

FIG. 9 is a block diagram illustrating a computing system of a thread discovery system, according to various embodiments.

FIG. 10 is a flow diagram illustrating a method for discovering an evolving threat campaign, according to various embodiments.

### DETAILED DESCRIPTION

The present disclosure relates to systems and methods for monitoring the evolution of cybersecurity threats and coordinated threat campaigns. With the knowledge and identity of malicious threat campaigns, it is possible to counteract attacks and provide other mitigation efforts against constantly developing threats. In a sense, the ever changing battle between malicious actors and cybersecurity professionals is a cat and mouse game, where improvements to the mouse traps are needed to counter new types of attacks.

The systems and methods of the present disclosure address these challenges by employing a multi-agent Generative Artificial Intelligence (GenAI) platform to enhance the speed, accuracy, and scalability of threat intelligence gathering, vetting, and dissemination. The systems or platforms therefore may be referred to as GenAI-Powered Evolving Threat Campaign Discovery systems. The present systems include GenAI powered threat intelligence collection from reliable web sources. The present disclosure describes scalable gathering systems (e.g., Web-based) and real-time processing of multi-modal sources (e.g., social media app feeds, tweets, threads, posts, etc.).

The present disclosure further describes automated correlation of various intelligence gathering data as well as trust-factor assessment. In some embodiments, the systems described herein may include multi-mode processing, where each mode may include multiple “agents” and where control systems are used to orchestrate the different agents. Some or all of the agents may involve GenAI, Machine Learning (ML), Large Language Models (LLMs), Natural Language Processing (NLP) chatbots, etc. The systems and methods described herein are configured to coordinate gathering, vetting, and processing threat campaigns, along with human-in-the-loop feedback. Queries may be processed to find and analyze threats, and then responses can be provided by communicating threat information to a threat specialist, taking automated actions, and/or providing recommendations for mitigating threats.

The systems and methods of discovering evolving threat campaigns, as described herein, use cutting-edge GenAI systems designed to proactively identify, analyze, and track evolving cybersecurity threat campaigns across the web. By leveraging advanced ML algorithms, efficient web crawling techniques, and intelligent correlation mechanisms, the discovery systems described in the present disclosure are configured to continuously scan and process vast amounts of data from diverse sources to detect patterns indicative of coordinated malicious activities, new attack vectors, and emerging threat actor tactics.

Some of the goals of the systems and methods described herein may include:
1) providing early warning and comprehensive intelligence on evolving threat landscapes, for use by experts and downstream applications;
2) intelligently crawling and analyzing web content to discover potential threat indicators;
3) correlating seemingly disparate pieces of information to identify coordinated campaigns;
4) tracking the evolution of threat actor Tactics, Techniques, and Procedures (TTPs) over time;
5) predicting potential future threat scenarios based on observed trends and patterns; and
6) continuously adapting detection and analysis capabilities to stay ahead of emerging threats.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

### Threat Intelligence System

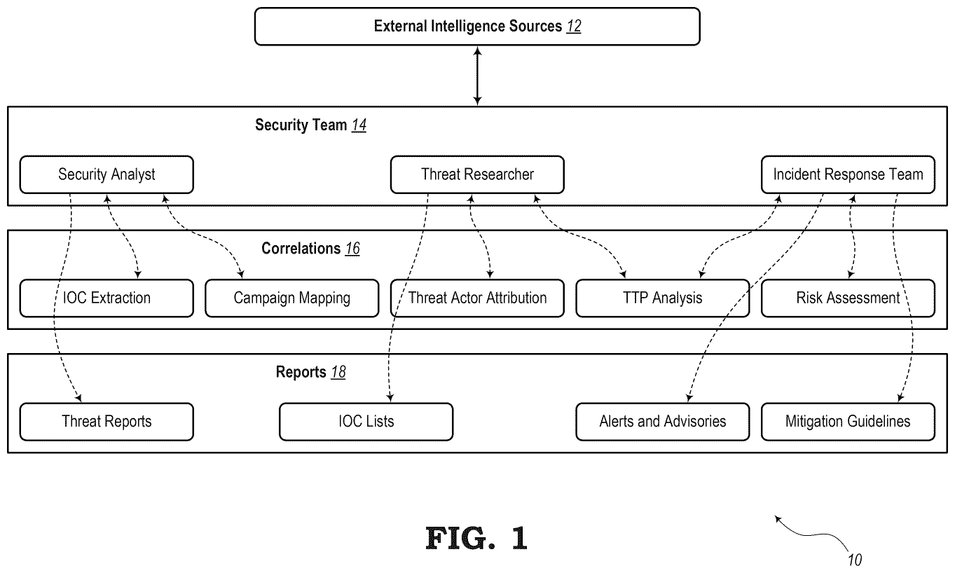

FIG. 1 is a block diagram illustrating an embodiment of a threat intelligence system 10. In this embodiment, the threat intelligence system 10 includes external intelligence sources 12, which can be referenced for obtaining valuable threat information. Also, the threat intelligence system 10 includes a security team 14, which may include manual components (e.g., human experts) as well as automated components. For example, the human side of the security team 14 may include security analysts, threat researchers, and incident response personnel. In response to research and analysis, the security team 14 may extract and assess certain correlations 16 from the gathered threat intel. Also, the security team 14 can provide reports 18 that can be used to document the histories of threats, threat actors, threat campaigns, alerts, mitigation strategies, etc.

As shown, the security analysts of the security team 14 may provide and/or access correlations 16 related to Indicators of Compromise (IOC) extractions and campaign mappings. The threat researchers of the security team 14 may provide and/or access correlations 16 related to threat actor attributes and Tactics, Techniques, and Procedures (TTP) analysis. Also, the incident response team of the security team 14 may provide and/or access correlations 16 related to TTP analysis and risk assessments. Furthermore, the security analysts may produce reports 18 related to threat reports, the threat researchers may produce reports 18 related to IOC lists, and the incident response team may produce reports 18 related to alerts, advisories, and mitigation guidelines.

In some respects, the threat intelligence system 10 may include aspects that are currently utilized in cybersecurity platforms for threat intelligence processing. As such, the threat intelligence system 10 of FIG. 1 may include multiple data pipelines that are not necessarily coordinated. Each pipeline may have unique update frequencies and may exchange data according to various formats. Also, the security team 14 may be semi-automated and may have a reliance on predefined sources of the external intelligence sources 12. However, even though the threat intelligence system 10 include many benefits over many cybersecurity systems, there is still room for the opportunity of improvements to advance threat detection and mitigation.

Up until now, cybersecurity systems may typically rely on certain external intelligence sources 12, such as VirusTotal, which is a website acquired by Google for scouring the web and aggregating many antivirus products and online scan engines. Files can be uploaded to the website to allow users to utilize the aggregated resources for checking their files for viruses that their own antivirus software may have missed. VirusTotal may also check for false positives detected by their antivirus software. VirusTotal and other threat detection and threat intelligence providers usually have teams that scour the web, dark web, etc., looking out for malicious content and signatures of emergent new threats and adding these new threats to a database of older ones.

Generally, there is a human element involved with the coordination of universal or macro level threats, such coordination efforts being provided by VirusTotal and other similar companies, for instance. A contributor may issue a concern regarding a suspicious that a certain Uniform Resource Locator (URL), Fully Qualified Domain Name (FQDN), or Internet Protocol (IP) address is harboring malicious software. Any user is free to submit this information, which can then be verified by a security team. After further research or after multiple users have submitted the same concerns, the URL, FQDN, or IP address may be added to the list of websites containing viruses.

The security analysts or threat researchers of the security team 14 within a company or organization may access these various feeds from VirusTotal or other external intelligence sources 12. In this way, they can gather information about a list of websites or feeds (e.g., Really Simple Syndication (RSS) feeds, etc.) that they may access on a regular basis to stay on top of what is happening in the realm of cybersecurity. Thus, a company may typically have its own intelligence gathering team which would gather this information and then vet it.

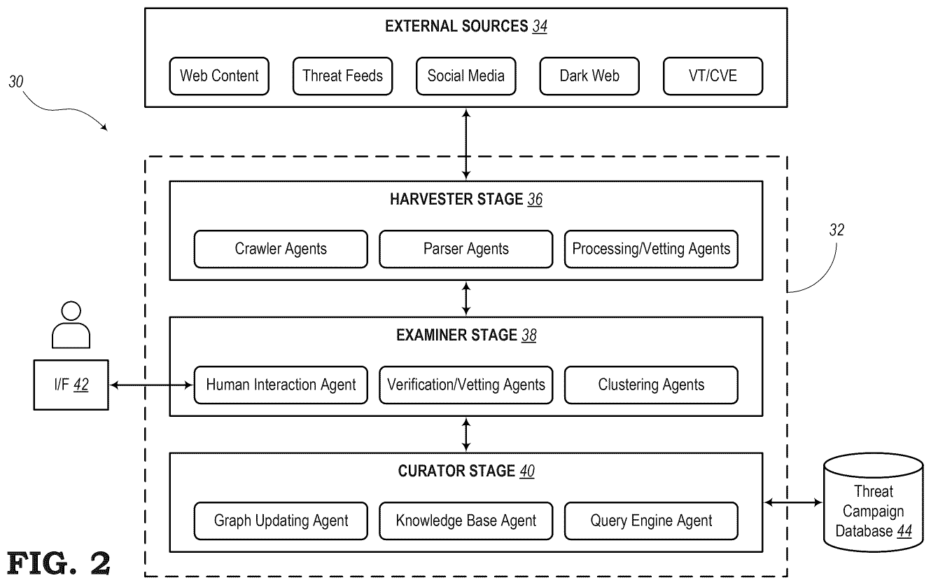

In some respect, the threat intelligence system 10 of FIG. 1 defines certain aspects of how threat intelligence is captured and used on a macro level today. The challenges of this system, however, are that each vendor offers these intelligence feeds using their own formats. As such, each of them has built custom pipelines having a format that users need to understand. Therefore, further embodiments are conceived that are configured to integrate different formats (e.g., using GenAI) to push various intel formats into a common data platform. For example, they may have their own update frequencies, but with automated flows, it is possible to adjust to the formats of different resources. Also, many of the human touch points in the threat intelligence system 10 can be replaced with automated processes (e.g., again using GenAI) within the various flowpaths between gathering data and implementing remediation efforts. Since scalability and recency (e.g., having access to the most up-to-date information) can be a problem at times, there may be a lag that can be caused by human involvement. These issues can be resolved by GenAI-powered discovery of threat campaigns and described in the present disclosure, particularly with respect to the embodiment described below and illustrated in FIG. 2.

### Additional Threat Intelligence System

FIG. 2 is a block diagram illustrating another embodiment of a threat intelligence system 30. The threat intelligence system 30, according to the embodiment of FIG. 2, includes a threat monitoring pipeline 32 for the discovery of evolving threat campaigns within a cybersecurity data managing framework. The threat monitoring pipeline 32 is configured to identify and uncover new or rapidly changing cyberattacks, often utilizing advanced techniques like threat intelligence, behavioral analysis, and ML to detect subtle IOCs within a network. The threat monitoring pipeline 32 may also be configured to dynamically adapt as malicious actors continuously modify their tactics to evade traditional security measures. The threat monitoring pipeline 32 is configured to actively search for and identify new attack campaigns that are constantly evolving in their methods and targets.

As shown in FIG. 2, the threat intelligence system 30 further includes external sources 34 accessible to the threat monitoring pipeline 32. For example, the external sources 34 may include web content, threat feeds, social media, the dark web, VirusTotal (VT) Common Vulnerabilities and Exposures (CVE), and/or other web-based sources.

The threat monitoring pipeline 32 in this embodiments includes a harvester stage 36, an examiner stage 38, and a curator stage 40. The three stages 36, 38, 40 of the threat monitoring pipeline 32 may include multiple agents configured to work cooperatively for processing cybersecurity threats and campaigns. In some embodiments, the harvester stage 36 may include crawler agents, parser agents, processing agents, among others. The examiner stage 38 may include a human interaction agent, verification/vetting agents, clustering agents, among others. The curator stage 40 may include graph updates, a knowledge base, a query engine, etc.

Generally, the architecture of the threat intelligence system 30 of FIG. 2 includes evolving threat campaign discovery having three primary components or stages working in a pipeline. The harvester stage 36 is configured for continuous open web crawling and initial threat clustering. The examiner stage 38 is configured for automated and human-assisted vetting of potential threats. The curator stage 40 is configured for versioned graph updates for maintaining the threat landscape.

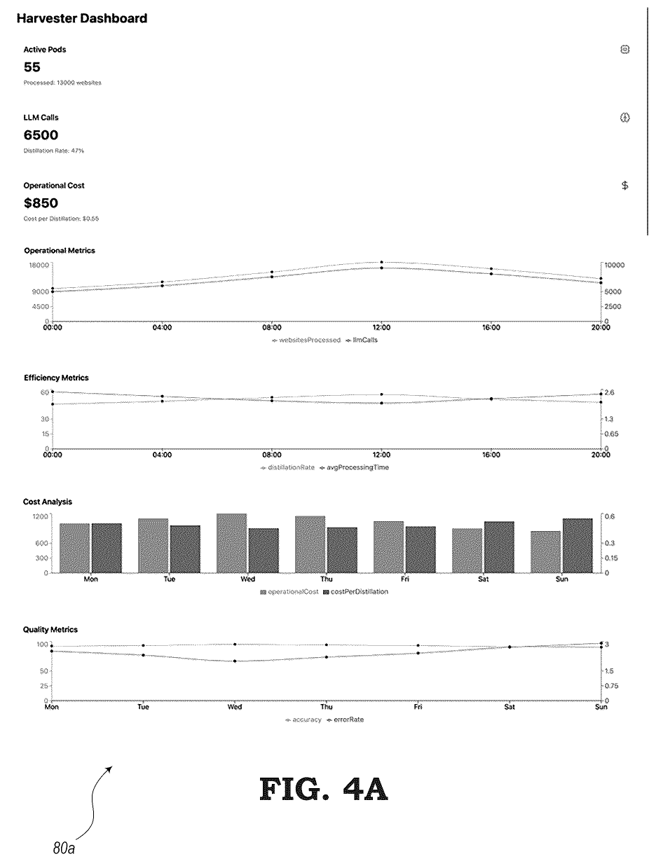

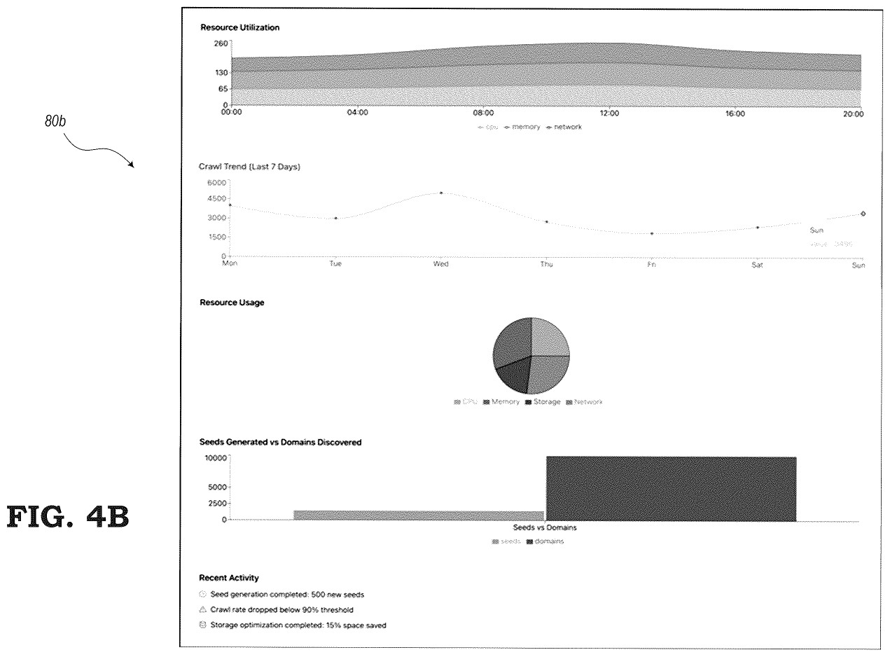

In particular, the harvester stage 36 may be a continuous component responsible for continuous open web crawling and initial threat clustering. The harvester stage 36 may include a) adaptive crawling patterns based on threat relevance, b) real-time prioritization of data sources, c) efficient parsing of structured and unstructured data, d) initial clustering of potential threat indicators, e) reinforcement learning for continuous improvement of crawling strategies, etc. The output of the harvester stage 36 may include a) a dataset of potential threat clusters, b) representation of harvested snapshots. Furthermore, the harvester stage 36 may include pseudo-random crawling based on seed generation, where seeds may be derived from a) web reports, b) converted documents/write ups provided by experts, c) observations from Internet access monitoring apps. The harvester stage 36 may be associated with a dashboard or other User Interface (UI) for displaying results, such as is shown in FIGS. 4A and 4B. In some cases, the harvester stage 36 may be constrained based on cost and time complexities of crawling and processing.

The examiner stage 38, for example, may also be a continuous component of the threat monitoring pipeline 32. The examiner stage 38 may be responsible for vetting the potential threats identified by the harvester stage 36. The examiner stage 38 may include a) automated vetting using machine learning models, web searches, trusted publications/repos/feeds, links, metadata, trust scores, etc., b) integration of human expert review for high-confidence threats, c) continuous refinement of vetting criteria, d) pattern recognition and anomaly detection, e) correlation of threat indicators to identify campaigns, etc. The output of the examiner stage 38 may include a) accepted, modified, or discarded threat snapshots, b) identified threat campaigns and their characteristics, etc. The human interaction agent of the examiner stage 38 may be configured to operate with a UI or Interface (I/F) 42 to enable a security specialist to view threat information and provide human “sanity” checks. The I/F 42 may allow a user to use a standardized Findings, Action, Reasoning, Result (FARR) format for augmentation. In some cases, the examiner stage 38 may be constrained based on cost and time complexities of auto-vetting and/or the availability of human experts for review.

In addition, the curator stage 40 may be configured as a gated type of component based on the cost and time constraints of the harvester stage 36 and examiner stage 38. Also, the curator stage 40 may use periodic updates for updating databases, knowledge bases, etc. The curator stage 40 may be responsible for updating a threat campaign database 44 based on the examined and accepted threat campaign snapshots. In some embodiments, the curator stage 40 may include a) versioned updates to the main database, b) merging of new threat information with existing knowledge, c) maintenance of historical threat evolution, d) predictive threat modeling for campaign progression, etc. The outputs of the curator stage 40 may include a) merged and versioned threat graph, b) threat campaign timelines and projections, etc. In some cases, the curator stage 40 may be constrained by scheduled or trigger-based execution of updates as well as verification of graph consistency and integrity methods.

Thus, the threat intelligence system 30 of FIG. 2 may provide many advantages over conventional systems. For example, the threat intelligence system 30 may include GenAI powered threat intelligence collection, such as web-scale gathering from the external sources 34, which may include multimodal access, social media apps, Tweets, threads, existing feeds, etc. Also, the threat intelligence system 30 may be configured for automated correlation and trust-factor assessment, multi-agent orchestration, natural interface for threat information retrieval, near real-time threat evolution insights, AI-platform based scalability, etc.

GenAI-powered evolving threat campaign discovery may include a natural language interface to allow the threat intelligence system 30 to act as a smart assistant for threat related queries. In some respects, the smart assistant may be considered to be an extension of the threat intelligence system 10 of FIG. 1 whereby the threat monitoring pipeline 32 is integrated or inserted between the external intelligence sources 12 and the security team 14 for providing the harvesting, examining, and curating functions for the security team 14. Using the I/F 42, the threat intelligence system 30 can provide user directed task scheduling to custom-tracking emergent threats.

Furthermore, the harvester stage 36 may allow the threat monitoring pipeline 32 to intelligently crawl and analyze web content to discover potential threat indicators. This may use GenAI agents for multi-modal content analysis and searches. The examiner stage 38 may be configured to correlate disparate pieces of information to identify coordinated campaigns. This may be done by tracking the evolution of threat actor Tactics, Techniques, and Procedures (TTPs) over time and may use GenAI agents to cross-check various co-related sources. The examiner stage 38 may also include predicting potential future threat scenarios based on observed trends and patterns and adapt its dynamic feeds to track emerging threats. Then, the curator stage 40 may be configured to provide comprehensive intelligence on evolving threat landscapes, which can be used by security experts and downstream applications.

The threat campaign database 44, for example, may be built around centralized threat campaigns, which may include historic data and a baseline threat campaign list. The threat campaign database 44 may include entities such as URLs, domains, IP addresses, geolocations, etc. The threat campaign database 44 may also store relationships, tags, etc. between entities. Furthermore, the threat campaign database 44 can include a structure that is optimized for efficient lookup to enable the merging of different use cases.

Therefore, GenAI may be integrated into any agents of the threat monitoring pipeline 32. The GenAI models may be incorporated throughout the pipeline to enhance threat campaign discovery and analysis. That is, the harvester stage 36 may include language models for context-aware parsing of web content and generative models for expanding search queries based on emerging patterns. The examiner stage 38 may include transformer-based models for automated threat assessment, Generative Adversarial Networks (GANs) for simulating potential attack scenarios, and neural networks for identifying correlations between threat indicators. The curator stage 40 may include updated graphs of neural networks for efficient threat graph updates and analysis, generative models for predicting potential threat evolution paths, sequence models for projecting campaign progression, etc.

In some implementations, the threat intelligence system 30 may be configured to replace the external intelligence sources 12 and security team 14. In this case, the threat intelligence system 30 may be adapted for gathering and unification in some sense, keeping the most up-to-date database and utilize a querying mechanism on top for the latest and most significant threats that are emerging, which can be accessed by any of the security analysts, threat researchers, the incident response team, etc. Thus, the threat intelligence system 30 can be a smart assistant for the security team 14 so that they do not need to perform individual manual searches. In a GenAI or LLM prompt field, the user may enter a query, such as “Tell me about any new developments in the field of Threat XYZ” and the threat intelligence system 30 can answer those kinds of questions.

With NLP, the GenAI and LLM mechanisms may understand sentiments and analyze text. If an attacker publishes a threat in real time, information about a threat, or information about a breach, such as on a Twitter account, Reddit forum, etc., the threat intelligence system 30 can use GenAI to pull that information from the various sources and process the threat accordingly. In some embodiments, the threat intelligence system 30 can also receive videos, images, etc., and pull threat information from these sources as well.

For example, the harvester stage 36 can automatically scour web content, social media (e.g., Twitter), existing thread feeds (e.g., VirusTotal), dark web websites, etc., based on queries or commands. Also, it can access VT/CVE databases, government published threat campaign information sites, etc. on a regular basis to obtain the most up-to-date information. Again, this can be done with user intervention, but instead can be done automatically and periodically according to available bandwidth. The threat intelligence system 30 can then take all of this information and then parse, process, and vet that information and keep it in a form that can be queried or looked up in future searches.

In an embodiment, for the harvester stage 36 in an example, LLM agents exhibit remarkable capabilities in processing multi-modal data, encompassing a diverse range of formats such as images, videos, and both unstructured and semi-structured text. These agents leverage advanced machine learning techniques to interpret and integrate information from various data types, enabling a more holistic understanding of complex contexts. For instance, when analyzing images, LLMs can identify objects, recognize patterns, and extract meaningful features, often correlating them with textual descriptions to provide rich, context-aware insights. Similarly, in video processing, they can detect temporal patterns, interpret actions, and extract key frames for detailed analysis. When dealing with text, whether unstructured (e.g., free-form natural language) or semi-structured (e.g., XML, JSON, or other tagged formats), LLM agents excel in parsing, organizing, and interpreting data to derive actionable insights. This capability allows them to understand context, infer relationships, and make predictions or decisions based on the provided information. By seamlessly integrating these multi-modal inputs, LLM agents enable applications ranging from enhanced content recommendation systems to sophisticated decision-support tools, significantly broadening the scope and impact of AI-driven solutions.

The threat intelligence system 30 is a multi-stage, multi agent system. The harvester stage 36 includes a crawler, parser, and processor for data gathering. Furthermore, the crawler agents may do more than simply get information. Based on receiving a question or query, the crawler agents can figure out a strategy for answering the question. For example, suppose a question is “Compare the behavior patterns between BlackCat and ALPHV ransomware infrastructures.” First, the threat intelligence system 30 would search in order to find out what BlackCat is, which may be done using a Google search, for example. It can also create a summary of what BlackCat is. Then, the system may do a second search for ALPHV, again one that may be a Google search to figure out this type of attack is. Then, in this case, a search may be done with respect to ransomware infrastructures and focusing on infrastructure segment of BlackCat and ALPHV, and then compare them (e.g., doing a “diff” process) to come up with the right summarized answer for the query.

Therefore, the threat intelligence system 30 may be configured to take a query or question, split it up, perform multiple Google-type searches (e.g., in an agentic fashion), one after another. Then, the threat intelligence system 30 can use a processing engine which basically understands what the final output the user is looking for, which of course can be more complicated than a simply web crawling function, but may involve analysis and NLP to arrive at a desired outcome.

The auto vetting process of the harvester stage 36 and/or examiner stage 38 may involve, in some embodiments, a reliance of a given question or query as well. It can pull in data from a website, even those that few people may normally use. The information it gets from that site, however, will be vetted. This may involve input or feedback from a user via the I/F 42 to determine if this is reliable information, if it is somebody playing a prank (e.g., “google.com is malicious”), or other conclusion. During the vetting process, the examiner stage 38 may be configured to determine if enough sources agree with a certain conclusion. For instance, if the number of sources reaches a predetermined threshold, then it can be determined as being a legitimate threat or potential concern requiring further investigation. Thus, the examiner stage 38 can ensure the validity of harvested information and/or can verify whether the gathered information is legitimate, with or without human interaction.

Once new threat information is confirmed, the threat intelligence system 30 is configured to provide an internal recordation method, such as storing the information in the threat campaign database 44, storing or updating a knowledge base, storing or updating graphs, charts, tables, etc., answering queries by a query engine, among other responses to discovering threats. Modification and/or update to threat records may include updating vector databases, GenAI vector databases, hybrid databases, etc. In some embodiments, additional responses may include automated mitigation actions, such as automatically blocking access to certain websites, preventing discovered malware from being run, reenforcing firewalls, applying additional security apps, etc.

According to one example, a user might request to “Show me the recent threat campaigns related to XYZ.” It may be noted that the word “recent” in this context may be taken to mean threat within the past x amount of time (e.g., last two weeks). This means that the user only wants up-to-date information. At that point in time, the threat intelligence system 30 can decide if it needs to control some agents to crawl the web to find the latest, greatest information for this particular threat actor. Once it collects the feeds, then the system parses those feeds or web pages. Then, if it gets, say, five different sets of information from five different pages, for instance, it needs to correlate this information to make sure that these source are referring to the same thing. The verification and vetting actions can be done by agents and/or may receive input from the user via the I/F 42 if necessary. If verification can be confidently determined without human involvement, the human interaction agent may be skipped, since the human-in-the-loop may not be needed for this example.

Essentially, the intelligence of the threat intelligence system 30 allows the GenAI interpretations to be performed automatically as much as possible, based on confidence that human involvement is not needed. This can help users focus on the more complex cases that are not so straightforward and may not be understood by automated processes. Therefore, an advantage of the threat intelligence system 30 is to help the security researchers, threat intelligence personnel, incident response teams, et al., to make them more productive, get answers more quickly, and provide more relevant and more recent answers.

In some cases, the threat intelligence system 30 may utilize a MITRE framework as a skeleton. As such, the MITRE framework can provide dependency tracking across threat vectors. Also, the threat intelligence system 30 can use GenAI to populate that schema very efficiently, using the agents shown in FIG. 2, because the agents can have particular specialties, such as excelling at web browsing.

An advantage over conventional systems is that normal databases do not have this specialized functionality, assisted by GenAI. For example, in a normal database, if a user asks a question, an answer can be provided if it exists from whatever data exists in the database, nothing more, nothing less. However, in the systems and methods of the present disclosure, the GenAI allow a more complete analysis of current and future threats and does not rely on old data in limited databases, but instead can continuously update searches, vet those searches, and continuously update internal databases. In particular, depending on how a question is asked, it might force the threat intelligence system 30 to repopulate a particular snapshot of data by looking across the web with fresh eyes. It can be dynamic in nature, not relying on static intel, such as intel from a pre-built database. Although the threat intelligence system 30 may start with a pre-built database or threat campaign database 44, it will dynamically grow and change as time goes on to stay on top of the latest threat campaigns.

In one case, a question may be raised that cannot be answered immediately. However, if phrased properly, such as, “Continue to monitor the XYZ threat campaign and keep me updated with daily reports every morning,” then the threat intelligence system 30 can then operate as instructed to periodically monitor for the threat campaign and prepare new graphs, charts, data, etc. regarding any new developments when they are detected.

### Example Workflow

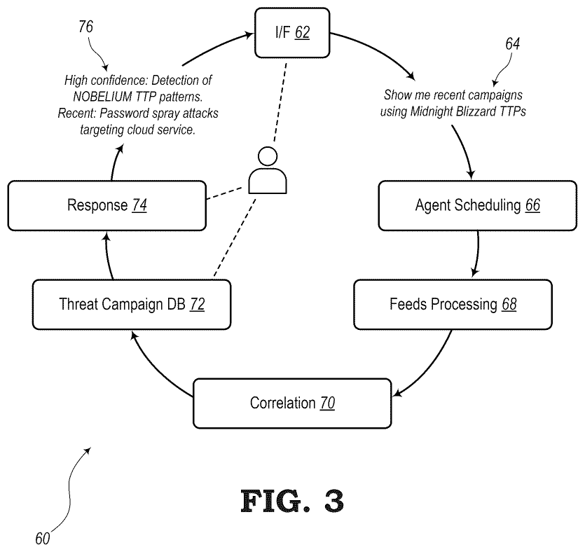

FIG. 3 is a flow diagram illustrating an embodiment of a process 60 for discovering threat campaigns. The process 60 starts with a user entering a query into an appropriate field of a threat intelligence application using any suitable type of UI, I/F, dashboard, etc. According to this example, an I/F 62 allows a user to enter a query 64, which states “Show me recent campaigns using Midnight Blizzard TTPs.” The query 64 is provided to agent scheduling 66, which may be configured as a GenAI module or controller. The agent scheduling may include background processing to employ certain agents for certain tasks. Next, the process 60 includes feeds processing 68, which may include auto-fetching actions, analysis, etc. the feeds processing 68 may include the actions of the harvester stage 36, for example.

Furthermore, the process 60 includes correlation 70, which may include mappings, redirections, etc. The task of correlation 70 may involve the actions of the examiner stage 38. Next, the process 60 includes a threat campaign database 72 (e.g., threat campaign database 44) for storing new or updated threat information. The storing of threat campaign information may include updating relationships, using timestamps, etc. and may involve the curator stage 40. After flowing through the pipeline, the process 60 further includes a response 74, which may include providing reports, insights, graphs, etc. and may be part of the curator stage 40 as well. For instance, one response may include answering the original query 64, where an answer 76 may include “High confidence: Detection of NOBELIUM TTP patterns. Recent: Password spray attacks targeting cloud service.” This answer 76 may be displayed, for example, on the I/F 62 or other user interface.

The process 60 may be implemented by a research assistant, security analyst, threat researcher, incident response team, threat analyst, or other type of user. For example, the user may be configured to enter “IOC Investigation” queries, such as:
A. “What are the known malicious activities associated with the Midnight Blizzard (NOBELIUM) C2 infrastructure?”
B. “Compare the behavioral patterns between BlackCat and ALPHV ransomware infrastructure.”
C. “Show me all variations of AsyncRAT associated with recent Minecraft modification campaigns.”

In some embodiment, the user may be configured to enter “Threat Campaign Analysis” queries, such as:
A. “Show me the evolution of Scattered Spider's tactics through 2023-2024”
B. “Show recent activities attributed to Water Hydra targeting cloud services”
C. “Show all C2 servers linked to recent Raspberry Robin infections”

In other embodiments, the user may be configured to enter “Emerging Threat Analysis” queries, such as:
A. “List emerging malware families targeting cloud service providers.”
B. “Show me attack pattern changes in Raspberry Robin over the past month.”
C. “What new obfuscation techniques have been observed in recent IcedID campaigns?”

IOC Investigator queries, such as those from an incident response person, may enter, “What are the known malicious activities associated with the Midnight Blizzard (NOBELIUM) C2 infrastructure?” or “Compare the patterns of behavior between Black Cat and ALPHV ransomware infrastructure” or other queries. These are example queries that they can put into an input field for an LLM of the text intelligence system 30.

A security researcher may ask the threat intelligence system 30, as if asking a smart assistant, “From now on, monitor this threat actor for any new changes in the behavior or attack procedures. Alert me when that happens.” When the system detects new threat information during an ongoing, continuous process, it can response to the user or researcher at a later time, whenever that information is discovered (or at a preset periodic reporting time). Also, the system can provide a natural language interface. It is a smart assistant for any threat related queries and the user can direct or offload tasks onto this platform, which it would carry out on its own, at its own frequency.

### Dashboards of Evolving Threat Campaign Discovery Pipeline

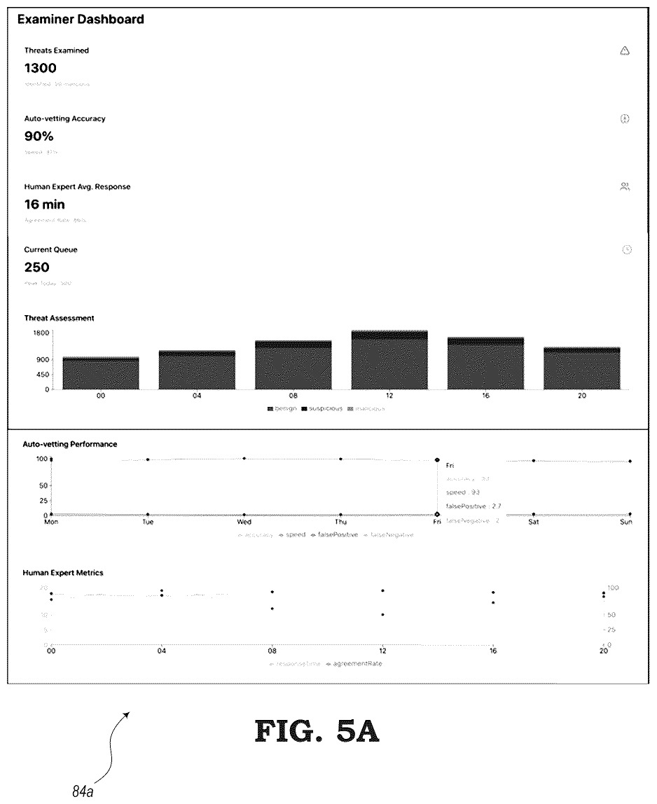

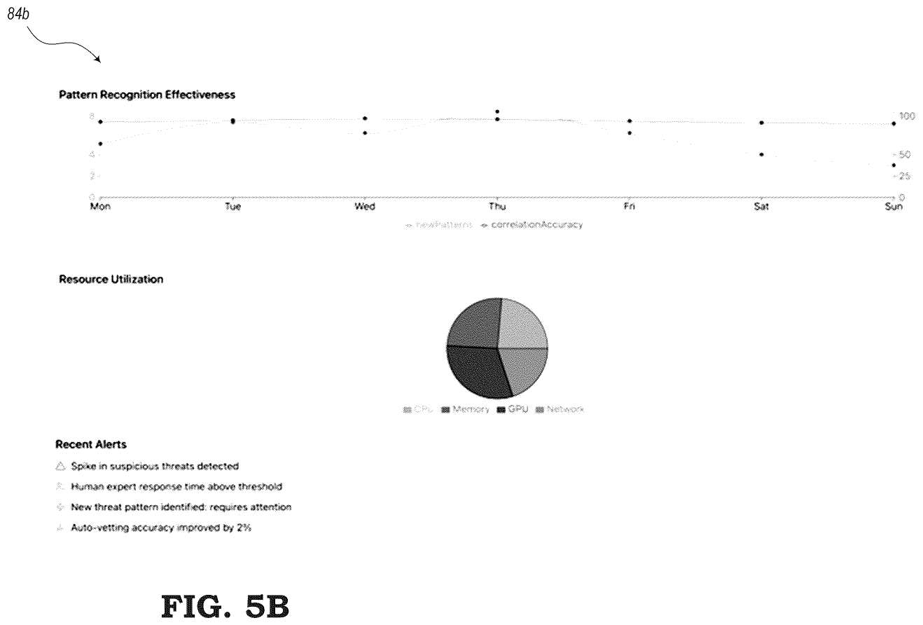

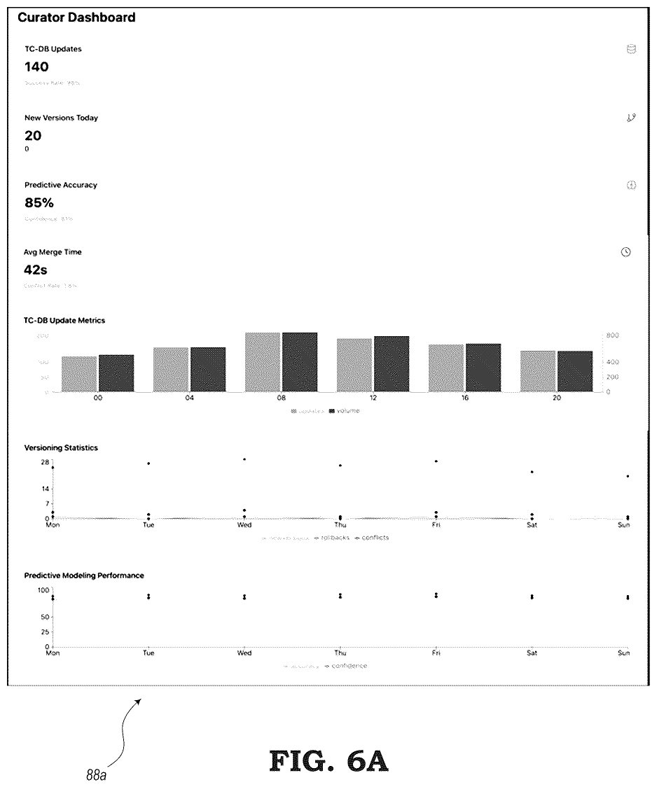

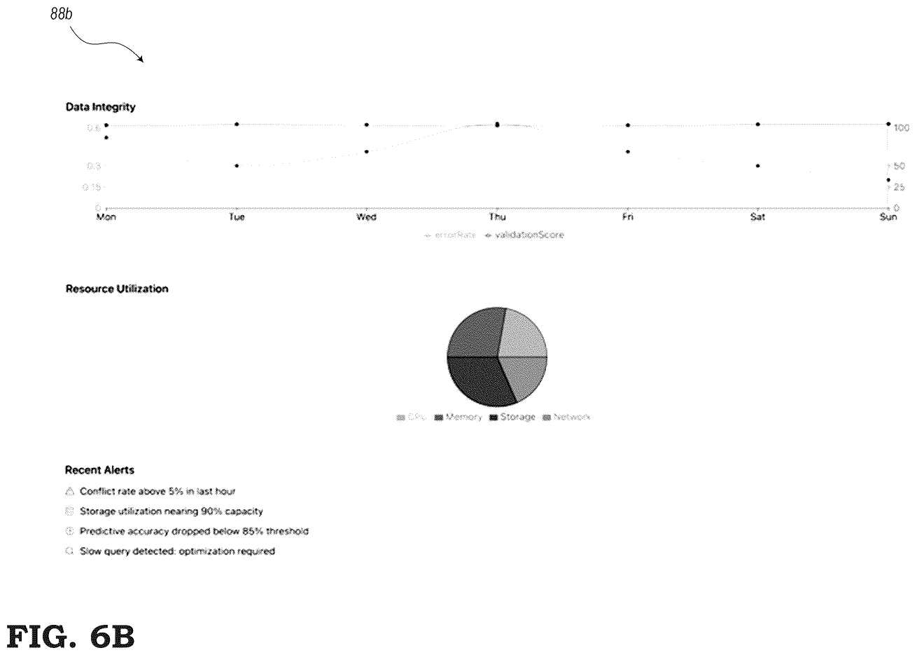

FIGS. 4A and 4B are screenshots 80a, 80b of a UI showing an example of a harvester dashboard, which may be related to utilization of the harvester stage 36. FIGS. 5A and 5B are screenshots 84a, 84b of a UI showing an example of an examiner dashboard, which may be related to utilization of the examiner stage 38. FIGS. 6A and 6B are screenshots 88a, 88b of a UI showing an example of a curator dashboard, which may be related to utilization of the curator stage 40.

### Threat Discovery Examples

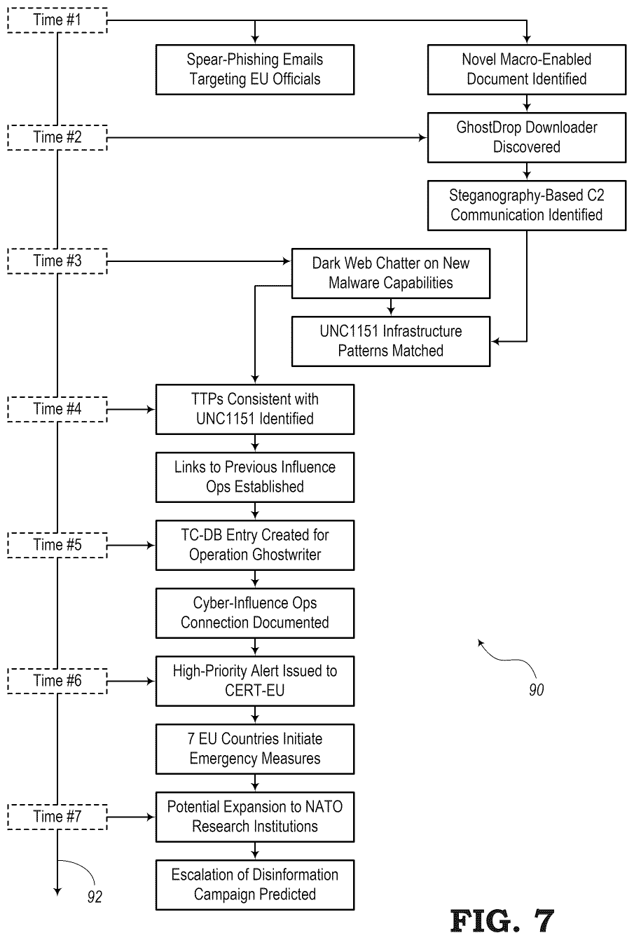

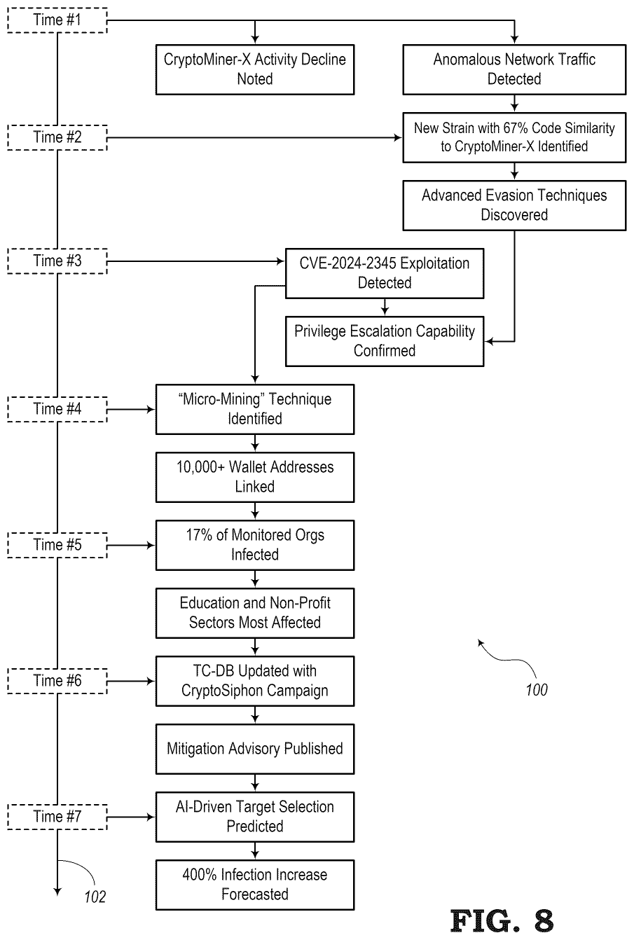

FIGS. 7 and 8 are flow diagrams illustrating examples of threat discovery processes. In FIG. 7, threats 90 are shown of “Operation Ghostwriter,” which may be defined as an Advanced Persistent Threat (APT) campaign. The threats 90 are detected at different times along a timeline 92 and may include dependencies on prior threats in some cases. In FIG. 8, threats 100 are shown of “CryptoSiphon,” which may be defined as an Evolving Cryptojacking Campaign. The threats 100 are detected at different times along a timeline 102 and may include dependencies on prior threats in some cases. The examples shown in FIGS. 7 and 8 show the sequence of operations by the threat intelligence system 30 according to various implementations.

### General-purpose Computing System

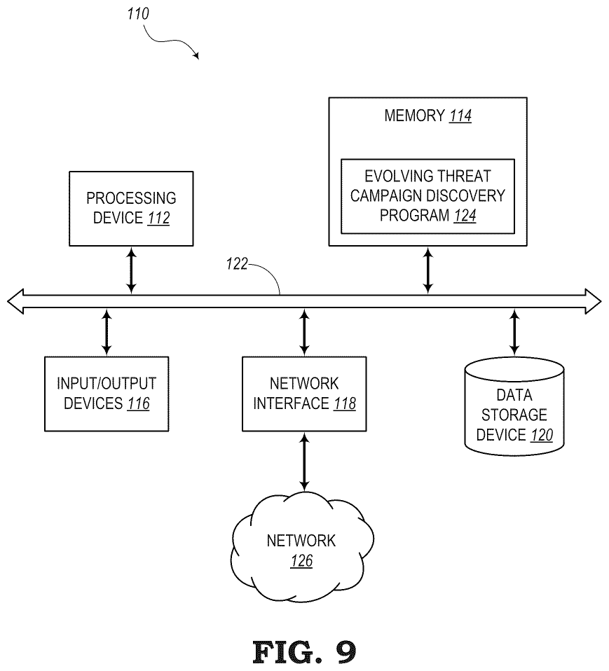

FIG. 9 is a block diagram illustrating an embodiment of a computing system 110 of a thread discovery system or framework, such as the threat intelligence systems 10, 30, the threat monitoring pipeline 32, etc. As shown in its simplified form, the computing system 110 includes a processing device 112, memory 114, Input/Output (I/O) devices 116, a network interface 118, and a data storage device 120 (or database), interconnected with each other via a local interface 122 (or bus).

The processing device 112 may include one or more processors or microprocessors, such as a Central Processing Unit (CPU), which is configured to execute instructions and process data. The processing device 112 may be a general-purpose processor, a special-purpose processor, an Application-Specific Integrated Circuit (ASIC), or any combination thereof. The processing device 112 is configured to perform various computational tasks and manage the operations of the computer system 80, including executing software instructions stored in the memory 114. In some embodiments, the processing device 112 may also include or be coupled to a Graphics Processing Unit (GPU), a Digital Signal Processor (DSP), or other specialized processing units that assist in performing specific functions such as image processing, machine learning, or data analysis. The processing device 112 may operate in conjunction with other components of the computing system 110, communicating via the local interface 122.

The memory 114 in the computer system 80 may include any combination of volatile and non-volatile memory components, such as Random-Access Memory (RAM), Read-Only Memory (ROM), flash memory, and other forms of computer-readable storage media. The memory 114 is configured to store software programs, applications, and data that are executed or processed by the processing device 112. The memory 114 may also store an Operating System (O/S) and/or operating instructions that manage the overall operation of the computing system 110. In some embodiments, the memory 114 may be further subdivided into different types, such as main memory (e.g., dynamic RAM) for temporary storage of active data, and secondary memory (e.g., non-volatile memory) for storing data persistently even when the system is powered down. The memory 114 may be dynamically allocated by the computing system 110, and it may be accessible by the processing device 112 and other components via the local interface 122.

The I/O devices 116 allow the computing system 110 to interact with a user, the external environment, and other systems. Input devices may include, but are not limited to, keyboards, mice, touchscreens, microphones, and other sensors or control devices that enable the user to input commands or data into the system. Output devices may include displays, printers, speakers, or haptic feedback devices that allow the computing system 110 to convey information or feedback to the user or external systems. In some embodiments, the I/O devices 116 may also include peripheral devices such as cameras, scanners, or biometric sensors. These I/O devices 116 may be directly connected to the computing system 110 or may communicate with the computing system 110 wirelessly, such as via the network interface 118.

The network interface 118 facilitates communication between the computing system 110 and external networks, such as network 126, a local area network (LAN), a wide area network (WAN), or the Internet. The network interface 118 may include both wired and wireless communication capabilities, such as Ethernet, Wi-Fi, Bluetooth, or other protocols. The network interface 118 enables the computer system 80 to transmit and receive data, connect to remote servers, or access cloud-based services. In some embodiments, the network interface 118 may be integrated with other components of the computing system 110 or implemented as a separate hardware module, and it may support various network protocols, including Transmission Control Protocol/Internet Protocol (TCP/IP), User Datagram Protocol (UDP), and others. The network interface 118 may also provide security features such as encryption, firewalls, and authentication mechanisms to ensure secure communication.

The data storage device 120 is configured to store data persistently, which may include structured data, unstructured data, program files, system logs, and other forms of digital information. The data storage device 120 may take various forms, such as a Hard Disk Drive (HDD), Solid-State Drive (SSD), or other non-volatile memory technologies. In some embodiments, the data storage device 120 is organized as a database, storing records, tables, and indexes that facilitate the efficient retrieval, updating, and management of data. The data storage device 120 may include multiple components and may be local to the computing system 110 and/or connected via a network to external storage resources, such as cloud-based storage platforms. The processing device 112 may interact with the data storage device 120 to retrieve and store data required for executing software applications, maintaining system logs, or providing data for analytical processes.

The various hardware components of the computing system 110, including the processing device 112, memory 114, I/O devices 116, network interface 118, and data storage device 120, communicate with each other over the local interface 122. This local interface 122 may be implemented as a bus, such as a system bus, memory bus, or input/output bus, which provides a communication pathway between the different components. The bus may be based on any standard bus architecture, including but not limited to Peripheral Component Interconnect (PCI), Universal Serial Bus (USB), or Advanced Microcontroller Bus Architecture (AMBA). In some embodiments, the local interface 122 may include multiple buses or communication channels that handle different types of data traffic, such as high-speed data transfers between the memory 114 and the processing device 112, or lower-speed communication with the I/O devices 116 or peripheral devices. The local interface 122 allows for the efficient exchange of data between components and ensures synchronized operation of the system.

In addition, the computing system 110 includes an evolving threat campaign discovery program 124, which may be implemented in any suitable combination of hardware (e.g., in the processing device) and/or software or firmware (e.g., in the memory 114). The evolving threat campaign discovery program 124 may be stored in non-transitory computer-readable media, such as the memory 114 and may include logic, software code, or the like, which is configured, when executed, to enable or cause the processing device 112 to perform certain threat analysis tasks, such as those described in the present disclosure.

According to some embodiments, the threat intelligence system may be configured as the computing system 110 and may include the processing device 112 and the memory 114. The memory 114 may be configured to store a computer program having instructions that, when executed, enable the processing device to utilize a harvester stage of an evolving threat campaign discovery pipeline. The harvester stage may include a continuous open web crawling action to obtain initial threat information from external sources. The instructions may further enable the processing device to utilize an examiner stage of the evolving threat campaign discovery pipeline, where the examiner stage may include automated and human-assisted vetting of the initial threat information to obtain verified threat data. Also, the instructions may enable the processing device to utilize a curator stage of the evolving threat campaign discovery pipeline, where the curator stage including a recording of the verified threat data in a threat campaign database to maintain knowledge of an evolving threat campaign.

### Method for Discovering Cybersecurity Threat Campaigns

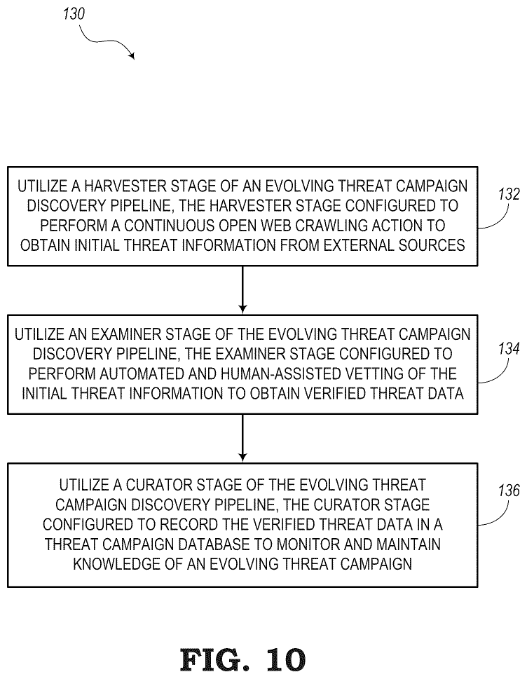

FIG. 10 is a flow diagram illustrating an embodiment of a method 130 for discovering an evolving threat campaign. In some embodiments, the method 130 may be performed by the evolving threat campaign discovery program 124 shown in FIG. 9 or other suitable computing component or system for monitoring and maintaining knowledge of an ongoing and evolving cybersecurity threat campaign. As shown in FIG. 10, the method 130 includes a step of utilizing a harvester stage of an evolving threat campaign discovery pipeline, as indicated in block 132, whereby the harvester stage is configured to perform a continuous open web crawling action to obtain initial threat information from external sources. Also, the method 130 includes a step of utilizing an examiner stage of the evolving threat campaign discovery pipeline, as indicated in block 134, whereby the examiner stage is configured to perform automated and human-assisted vetting of the initial threat information to obtain verified threat data. Furthermore, the method 130 includes a step of utilizing a curator stage of the evolving threat campaign discovery pipeline, as indicated in block 136, whereby the curator stage is configured to record the verified threat data in a threat campaign database to maintain knowledge of an evolving threat campaign. According to some embodiments, GenAI models are integrated in one or more of the harvester stage, examiner stage, and curator stage of the evolving threat campaign discovery pipeline.

In some embodiments, the method 130 may further include additional features, as described herein. For example, the harvester stage may include one or more Large Language Models (LLMs) for context-aware parsing of the initial threat information. The harvester stage may also include an expansion of search queries based on emerging patterns. The examiner stage, for instance, may include transformer-based models for automated threat assessment to validate the credibility of the initial threat information. Also, the examiner stage may further include one or more Generative Adversarial Networks (GANs) for simulating potential attack scenarios and/or may further include one or more neural networks for identifying correlations between threat indicators. In addition, the curator stage may include one or more of a) graph neural networks for efficient threat graph updates and analysis, b) generative models for predicting potential threat evolution paths, and c) sequence models for projecting campaign progression.

The evolving threat campaign discovery pipeline, according to some implementations, may include multiple agents for manual and automated processing. The external sources, for instance, may include websites, threat feeds, VirusTotal, social media, dark web, Common Vulnerabilities and Exposures (CVE) sites, and/or government-maintained threat lists. The threat campaign database, in some embodiments, may include a hybrid database, a knowledge base, and/or a vector database. In some embodiments, a User Interface (UI) may be configured to receive queries (from a user or security specialist), interpret the queries using Natural Language Processing (NLP), initiate the evolving threat campaign discovery pipeline, and respond to the queries using NLP.

### Additional Considerations

The systems and methods of the present disclosure are configured to introduce a multi-agent system powered by GenAI, designed to automate and optimize threat intelligence workflows. The systems are configured to incorporate a) Data Crawlers, which may include automated agents to scour diverse data sources, including open web content, social media platforms, and dark web forums, b) Examiners and Vetting Agents, which may include modules that evaluate data reliability through cross-referencing and confidence scoring, incorporating human input where necessary, c) Knowledge Graph and Hybrid Databases, where dynamic storage systems combine structured (knowledge graph) and unstructured (vector database) representations, and d) Natural Language Interfaces to provide a user-friendly interface enabling security analysts, threat researchers, and incident responders to query and interact with the system dynamically.

The present systems ensure real-time updates to its internal database and dynamically adjusts its processes based on user queries, providing a robust and scalable solution for threat intelligence management. The systems may be configured in a multi-stage platform including Data Acquisition components, such as web crawlers, whereby specialized agents continuously harvest data from external sources, including websites, social media, RSS feeds, government threat databases, and the dark web. These agents dynamically adjust their search criteria based on specific threat intelligence requirements. The systems may also include Parser components, such as specialized agents that extract and normalize data from diverse formats, preparing it for further analysis. Also, the systems may include Data Vetting and Analysis components, such as specialized agents configured as Examiners or AI elements that evaluate the reliability of gathered data using machine learning models trained on historical threat intelligence. These agents can cross-reference information across sources and assign confidence scores. These agents can also include Human-in-the-Loop feedback mechanisms to allow human experts to validate or reject low-confidence data, improving the system's learning and accuracy over time. In addition, the systems may include Knowledge Representation components, which may include specialized agents for storing threat campaign information is an accessible and cross-checked manner to coordinate multiple sources for universal collaborative identity, reporting, and remediation efforts to battle against threat campaigns worldwide.

Threat campaign databases may include Hybrid Databases, which combine structured knowledge graphs (to map threat actor relationships, tactics, and indicators) with a vector database (to enable semantic search and generative query resolution). Also, the threat campaign databases are configured for Continuous Updates, whereby the evolving threat campaign discovery pipeline can perform periodic or on-demand refreshing actions to its data repository to reflect the latest threat landscape.

Also, with User Interaction mechanisms, such as Natural Language Interfaces and the like, a chatbot-like assistant can interpret user queries, trigger relevant agents, and provide detailed insights. User Interaction mechanisms may also include Dynamic Query Handling components, whereby the systems, methods, and pipelines can execute real-time searches and analysis if data for a query is not pre-existing in a database.

Therefore, according to the various implementations described in the present disclosure, the evolving threat campaign discovery pipelines provide multiple advantages with respect to conventional methodologies. For example, the embodiments of the present disclosure are configured for greater Speed and Scalability to enable real-time threat detection and analysis, significantly reducing the time lag inherent in traditional systems. Also, the present embodiments are configured for Dynamic Query Resolution to adapt to user queries by performing real-time searches and updating the database dynamically. The systems and methods of the present disclosure are also configured for Enhanced Accuracy by incorporating multiple AI agents, along with human validation, to enhance confidence scoring and ensure data reliability. Furthermore, the present systems and pipelines include User-Friendly Interaction to provide a natural language interface, simplifying complex threat intelligence workflows. Also, the present systems and methods include Comprehensive Coverage by gathering data from diverse sources, not just a limited number of sources, which includes harvesting from unconventional platforms, like social media and the dark web.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A threat intelligence system comprising:
a processing device, and
a memory device configured to store a computer program having instructions that, when executed, enable the processing device to
utilize a harvester stage of an evolving threat campaign discovery pipeline, the harvester stage configured to perform a continuous open web crawling action to obtain initial threat information from external sources,
utilize an examiner stage of the evolving threat campaign discovery pipeline, the examiner stage configured to perform automated and human-assisted vetting of the initial threat information to obtain verified threat data, and
utilize a curator stage of the evolving threat campaign discovery pipeline, the curator stage configured to record the verified threat data in a threat campaign database to monitor and maintain knowledge of an evolving threat campaign.

2. The threat intelligence system of claim 1, wherein Generative Artificial Intelligence (GenAI) models are integrated in one or more of the harvester stage, examiner stage, and curator stage of the evolving threat campaign discovery pipeline.

3. The threat intelligence system of claim 1, wherein the harvester stage includes one or more Large Language Models (LLMs) for context-aware parsing of the initial threat information.

4. The threat intelligence system of claim 1, wherein the harvester stage includes an expansion of search queries based on emerging patterns.

5. The threat intelligence system of claim 1, wherein the examiner stage includes transformer-based models for automated threat assessment to validate credibility of the initial threat information.

6. The threat intelligence system of claim 1, wherein the examiner stage includes one or more Generative Adversarial Networks (GANs) for simulating potential attack scenarios.

7. The threat intelligence system of claim 1, wherein the examiner stage includes one or more neural networks for identifying correlations between threat indicators.

8. The threat intelligence system of claim 1, wherein the curator stage includes one or more of a) graph neural networks for efficient threat graph updates and analysis, b) generative models for predicting potential threat evolution paths, and c) sequence models for projecting campaign progression.

9. The threat intelligence system of claim 1, wherein the evolving threat campaign discovery pipeline includes multiple agents for manual and automated processing.

10. The threat intelligence system of claim 1, wherein the external sources include one or more of websites, threat feeds, VirusTotal, social media, dark web, Common Vulnerabilities and Exposures (CVE) sites, and government-maintained threat lists.

11. The threat intelligence system of claim 1, wherein the threat campaign database includes one or more of a hybrid database, a knowledge base, and a vector database.

12. The threat intelligence system of claim 1, further comprising a User Interface (UI) configured to receive queries, interpret the queries using Natural Language Processing (NLP), initiate the evolving threat campaign discovery pipeline, and respond to the queries using NLP.

13. A non-transitory computer-readable medium configured to store computer logic having instructions that, when executed, cause one or more processing devices to:
utilize a harvester stage of an evolving threat campaign discovery pipeline, the harvester stage configured to perform a continuous open web crawling action to obtain initial threat information from external sources;
utilize an examiner stage of the evolving threat campaign discovery pipeline, the examiner stage configured to perform automated and human-assisted vetting of the initial threat information to obtain verified threat data; and
utilize a curator stage of the evolving threat campaign discovery pipeline, the curator stage configured to record the verified threat data in a threat campaign database to monitor and maintain knowledge of an evolving threat campaign.

14. The non-transitory computer-readable medium of claim 13, wherein Generative Artificial Intelligence (GenAI) models are integrated in one or more of the harvester stage, examiner stage, and curator stage of the evolving threat campaign discovery pipeline.

15. A method comprising steps of:
utilizing a harvester stage of an evolving threat campaign discovery pipeline, the harvester stage configured to perform a continuous open web crawling action to obtain initial threat information from external sources;
utilizing an examiner stage of the evolving threat campaign discovery pipeline, the examiner stage configured to perform automated and human-assisted vetting of the initial threat information to obtain verified threat data; and
utilizing a curator stage of the evolving threat campaign discovery pipeline, the curator stage configured to record the verified threat data in a threat campaign database to monitor and maintain knowledge of an evolving threat campaign.

16. The method of claim 15, wherein the harvester stage includes one or more of:
one or more Large Language Models (LLMs) for context-aware parsing of the initial threat information; and
an expansion of search queries based on emerging patterns.

17. The method of claim 15, wherein the examiner stage includes one or more of:
transformer-based models for automated threat assessment to validate credibility of the initial threat information;
one or more Generative Adversarial Networks (GANs) for simulating potential attack scenarios; and
one or more neural networks for identifying correlations between threat indicators.

18. The method of claim 15, wherein the curator stage includes one or more of:
graph neural networks for efficient threat graph updates and analysis;
generative models for predicting potential threat evolution paths; and
sequence models for projecting campaign progression.

19. The method of claim 15, wherein the evolving threat campaign discovery pipeline includes multiple agents for manual and automated processing, and wherein the external sources include one or more of websites, threat feeds, VirusTotal, social media, dark web, Common Vulnerabilities and Exposures (CVE) sites, and government-maintained threat lists.

20. The method of claim 15, wherein the threat campaign database includes one or more of a hybrid database, a knowledge base, and a vector database, and wherein a User Interface (UI) is configured to receive queries, interpret the queries using Natural Language Processing (NLP), initiate the evolving threat campaign discovery pipeline, and respond to the queries using NLP.
